(19) United States
(12) Patent Application Publication
(10) Pub. No.: US 2026/0292441 A1
(43) Pub. Date: Sep. 24, 2026

(54) MOTION-TRIGGERED LOCATION TRACKING AND NOTIFICATION SYSTEM

(71) Applicant: GPS Special.com LLC, Clearwater Beach, FL (US)

(72) Inventor: Abdelgawa Abdelkader, Clearwater, FL (US)

(21) Appl. No.: 19/475,322

(22) PCT Filed: Apr. 23, 2024
(86) PCT No.: PCT/US2024/025858

§ 371 Date: Oct. 14, 2025

Related U.S. Application Data
(60) Provisional application No. 63/497,862, filed on Apr. 24, 2023.

(51) Int. Cl. H04W 4/02; H04M 1/72436; H04W 4/021

(52) U.S. Cl. CPC H04W 4/023; H04M 1/72436; H04W 4/021; H04M 2201/42; H04M 2250/12

(57) ABSTRACT

A method implemented at a mobile device is provided. The method includes: detecting a motion of the mobile device to generate a motion signal; determining that the motion signal is indicative of a shaking movement associated with the mobile device; transmitting a location of the mobile device to a server; receiving, from the server, a signal indicating users, offers or entities located within a distance from the location of the mobile device; and displaying a notification indicating the users, offers or entities located within the distance from the location of the mobile device.

### CROSS-REFERENCE TO RELATED APPLICATIONS

This application claims priority to U.S. Provisional Patent Application No. 63/497,862, entitled “MOTION-TRIGGERED LOCATION TRACKING AND NOTIFICATION SYSTEM,” filed on Apr. 24, 2023, the disclosure of which is hereby incorporated by reference in its entirety and for all purposes.

### TECHNICAL FIELD

The present disclosure relates to systems and methods for triggering location tracking, data integration, and visualization. More specifically, this disclosure relates to motion-triggered display of location-based notifications to users, and related interactions between users.

### BACKGROUND

User devices, including portable electronics such as smart phones or tablets, commonly enable a determination as to their location. For example, a smart phone may include a global navigation satellite system (GNSS) receiver which can map the smart phone onto specific coordinates on Earth (e.g., WGS84, EGM96, EGM2008, and so on). Applications executing on a smart phone, for example applications obtained from an electronic application store, may utilize the smart phone's location to perform various functions. For example, a geofence may be established for a particular geographic area and actions may be taken in response to user devices entering or exiting the geofence. An application may identify locations of users that are within a geofenced area and provide communications to those users.

Accordingly, there is ongoing development in applications which take advantage of location tracking in conjunction with geofencing.

### SUMMARY

As will be described in more detail, applications and systems that link users, offers and entities, such as businesses (of any type including restaurants), may be improved via the techniques described herein. For example, a user of a mobile device may trigger a notification from a server regarding users, offers or entities within a distance from the user by shaking the mobile device. Based on the notification, the user may select other users, offers or entities within the distance for further interactions. In contrast to prior applications where a user may need to navigate through various icons or screen pages of the GUI before certain information exchange may be triggered, the user may easily and quickly receive information to act on by shaking the mobile device. Advantageously, this may improve the useability of the device and increase the likelihood that the user will use the application and related search capabilities.

In some embodiments, the notification associated with the shaking advantageously allows a user of a mobile device to initiate a search of users, offers, entities or businesses around the user of the mobile device by shaking the mobile device. In some embodiments, responsive to a shaking of the mobile device, a notification from a server may include information (e.g., offers, deals or the like) associated with entities or businesses that are stored in a database of the server. In some embodiments, the shaking of the mobile device may trigger a search and a selection of desired information (e.g., offers, deals or the like) stored in the database of the server

In some embodiments, the techniques described herein relate to a computer-implemented method implemented at a mobile device, the mobile device including a sensor, a processing unit and a display, the method including: detecting, by the sensor, a motion of the mobile device; generating, by the sensor, a motion signal based on the motion; determining, by the processing unit, the motion signal is indicative of a shaking movement associated with the mobile device; transmitting, to a server, a location of the mobile device; receiving, from the server, a signal indicating users, offers or entities located within a distance from the location; and displaying, by the display, a notification indicating the users, offers or entities located within the distance from the location.

In some embodiments, the techniques described herein relate to a computer-implemented method, further including: determining, by the processing unit, a first feature of the motion signal; and determining, by the processing unit, the first feature exceeds a threshold.

In some embodiments, the techniques described herein relate to a computer-implemented method, wherein in response to determining the first feature exceeds the threshold, the processing unit transmits the location of the mobile device and the first feature to the server.

In some embodiments, the techniques described herein relate to a computer-implemented method, wherein in response to determining the first feature exceeds the threshold, the processing unit transmits a request for the signal indicating the users, offers or entities located within the distance from the location of the mobile device.

In some embodiments, the techniques described herein relate to a computer-implemented method, wherein the first feature corresponds to a temporal duration of the shaking movement.

In some embodiments, the techniques described herein relate to a computer-implemented method, wherein the mobile device is configured to transmit a message indicative of the distance to the server, wherein the distance varies with the temporal duration.

In some embodiments, the techniques described herein relate to a computer-implemented method, wherein the distance further varies based on a density of potential users, offers or entities that are eligible to be indicated in the signal.

In some embodiments, the techniques described herein relate to a computer-implemented method, wherein the distance is positively correlated with the first feature.

In some embodiments, the techniques described herein relate to a computer-implemented method, wherein the first feature is a velocity of the shaking movement or a distance range of the shaking movement.

In some embodiments, the techniques described herein relate to a computer-implemented method, wherein the notification includes identification of a first user, wherein location information of the first user is transmitted to the server within a first time interval before the location of the mobile device is transmitted to the server.

In some embodiments, the techniques described herein relate to a computer-implemented method, wherein the location information of the first user is transmitted to the server in response to a shaking movement associated with another mobile device of the first user.

In some embodiments, the techniques described herein relate to a computer-implemented method, further including: presenting, via the display, a user interface including a list of entries, wherein the list of entries includes the users indicated in the signal; receiving a selection of a first entry of the list of entries included in the user interface, wherein the first entry corresponds to a first user of the users; and causing a message, a coupon, or a gift card to be transmitted to another mobile device of the first user.

In some embodiments, the techniques described herein relate to a computer-implemented method, further including: presenting, via the display, a user interface including a map; determining the shaking movement associated with the mobile device occurs during the presentation of the user interface including the map; and in response to determining the shaking movement associated with the mobile device occurs during the presentation of the user interface including the map, presenting, via the display, deals associated with the entities located within the distance from the location.

In some embodiments, the techniques described herein relate to a computer-implemented method, wherein the deals vary based on previous orders placed by the mobile device.

In some embodiments, the techniques described herein relate to a computer-implemented method, wherein the deals vary based on previous orders placed by other mobile devices during a first time interval.

In some embodiments, the techniques described herein relate to a computer-implemented method, further including: presenting, via the display, a user interface including a business page; determining the shaking movement associated with the mobile device occurs during the presentation of the user interface including the business page; and in response to determining the shaking movement associated with the mobile device occurs during the presentation of the user interface including the business page, presenting, via the display, a business menu.

In some embodiments, the techniques described herein relate to a computer-implemented method, further including: presenting, via the display, a user interface including a coupon page; determining the shaking movement associated with the mobile device occurs during the presentation of the user interface including the coupon page; and in response to determining the shaking movement associated with the mobile device occurs during the presentation of the user interface including the coupon page, causing coupons associated with the entities indicated in the signal be obtained by the mobile device.

In some embodiments, the techniques described herein relate to a computer-implemented method implemented at a server, the method including: receiving, from a mobile device, a location of the mobile device; receiving, from the mobile device, a feature of a motion signal; generating a distance based on the feature; identifying users, offers or entities within the distance from the location of the mobile device; and transmitting, to the mobile device, a signal indicating users, offers or entities located within the distance from the location of the mobile device.

In some embodiments, the techniques described herein relate to a computer-implemented method, wherein generating the distance includes: comparing the feature to one or more thresholds to generate a comparison result; and generating the distance based on the comparison result.

In some embodiments, the techniques described herein relate to a computer-implemented method, wherein the feature corresponds to a temporal duration of a shaking movement associated with the mobile device.

In some embodiments, the techniques described herein relate to a computer-implemented method, wherein the distance varies with the temporal duration.

In some embodiments, the techniques described herein relate to a computer-implemented method, wherein the distance is positively correlated with the feature.

In some embodiments, the techniques described herein relate to a computer-implemented method, wherein the distance varies based on a density of potential users, offers or entities that are eligible to be indicated in the signal.

In some embodiments, the techniques described herein relate to a computer-implemented method, further including: receiving location information of another mobile device associated with a first user, wherein the first user is indicated in the signal, and wherein the location information is received within a first time interval before the location of the mobile device is received.

In some embodiments, the techniques described herein relate to a computer-implemented method, wherein the location information is received in response to a shaking movement associated with the another mobile device associated with the first user.

In some embodiments, the techniques described herein relate to a computer-implemented method, further including: transmitting deals associated with the entities located within the distance from the location.

In some embodiments, the techniques described herein relate to a computer-implemented method, further including: filtering the deals associated with the entities located within the distance from the location based on previous orders associated with the mobile device.

In some embodiments, the techniques described herein relate to a computer-implemented method, further including: filtering the deals associated with the entities located within the distance from the location based on previous orders associated with other mobile devices.

Accordingly, in various embodiments, large amounts of data are automatically and dynamically calculated interactively in response to user inputs, and the calculated data may be efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above-and/or below-described embodiments (including one or more aspects of the appended claims).

In various embodiments, computer-implemented methods are disclosed in which, by one or more processors executing program instructions, one or more aspects of the above-and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above-and/or below-described embodiments (including one or more aspects of the appended claims).

It will be appreciated that embodiments disclosed herein may be used in various applications, methods and systems, such as those disclosed in U.S. Pat. No. 11,120,422, issued Sep. 14, 2021 and titled “GEOFENCE-BASED LOCATION TRACKING AND NOTIFICATION TRIGGERING SYSTEM,” the entirety of which is hereby incorporated by reference.

### BRIEF DESCRIPTION OF THE DRAWINGS

Various embodiments are described with reference to the accompanying drawings, in which like reference characters reference like elements, and wherein:

FIG. 1 depicts an example block diagram of a system in which some embodiments of the present disclosure may be implemented to generate motion-triggered notifications to a user.

FIG. 2 depicts an example block diagram representative of the mobile device of FIG. 1.

FIG. 3A illustrates an example of a perspective view of shaking of the mobile device of FIG. 1.

FIG. 3B illustrates an example of interactions between elements of the mobile device of FIG. 1 in some embodiments.

FIG. 4 illustrates an example routine for triggering notification indicating users, offers or entities located within a geofence of a mobile device, such as the mobile device of FIG. 1.

FIG. 5 illustrates an example routine that may be implemented by the server of FIG. 1 for providing information associated with users, offers or entities within a geofence of a mobile device.

FIG. 6 depicts an example architecture of the mobile device of FIG. 1.

FIG. 7 illustrates an example interface presented on a mobile device in response to a motion associated with the mobile device.

FIG. 8 illustrates an example user interface that may be motion-triggered to be displayed on a mobile device, such as the mobile device of FIG. 1.

FIG. 9 illustrates an example user interface that may be displayed on a mobile device, such as the mobile device of FIG. 1, in response to a user shaking the mobile device.

FIG. 10 illustrates an example interface presented on a mobile device in response to a motion associated with the mobile device, such as the mobile device of FIG. 1.

FIG. 11 illustrates an example user interface that may be displayed on a device through which offers can be presented to potential customers.

FIG. 12 illustrates an example user interface that may be displayed on a mobile device, such as the mobile device of FIG. 1, in response to a user shaking the mobile device.

### DETAILED DESCRIPTION

When providing communications with users, for example within a geofenced area, some mobile devices allow users to initiate geofence-based notification services through manipulations on a graphical user interface (GUI). For example, a user may utilize a GUI to facilitate transmission and reception of information with or regarding other users, offers, or entities that are located within a geofence associated with the user. However, the user may need to navigate through various icons or screen pages of the GUI before a desired geofence-based information exchange is triggered. Such navigation may be inconvenient, slow, and/or may result in application fatigue.

Advantageously, in some embodiments, the motion of a mobile device may be used to trigger exchange of information with or regarding users, offers, or entities within a set distance or geofence of the mobile device. For example, a user of a mobile device may trigger reception of a notification from a server regarding users, offers or entities within a set distance (e.g., 100 meters, 500 meters and 1000 meters) from the user by shaking the mobile device. As such, the user may receive information regarding users, offers or entities within a geofence surrounding the user by simply shaking the user's mobile device. In some embodiments, the amount of information received by the user may be adjusted based on the duration (e.g., 2 seconds, 4 seconds and 6 seconds) that the user shakes the mobile device. It will be appreciated that a geofence may be defined as a virtual perimeter for a real-world geographic area. A geofence may be a particular shape, such as a polygon or oval, and may encompass different sizes of geographic areas. In some embodiments, the geofence may surround a location of the user's mobile device, where the location may be provided by a global positioning system (GPS). As such, some embodiments may provide GPS-based search ability for the user of the mobile device to enable the user to identify users, offers, entities (e.g., businesses including restaurants or venues) around the user for further interactions. Also, the entities displayed in the notifications may be any type of businesses, such as restaurants.

In some embodiments, the distance or size of the geofence around the mobile device of the user may increase (or the geofence may enlarge) as the user shakes the mobile device for a longer duration. For example, the distance may be 100 meters if the user shakes the mobile device for 2 seconds but may increase to 300 meters if the user shakes the mobile device for 4 seconds. Additionally or optionally, the distance may further vary based on density of relevant users, offers or entities within a geographic region the user is located. For example, the rate at which the size of the geofence increases with the shake duration may vary based on the density of users, offers, or entities within the geofence. In some embodiments, the rate of increase of the size of the geofence is negatively correlated with the density of users, offers, or entities within the geofence; a relatively high density of users, offers, or entities would result in a relatively small increase in the size of the geofence for a given shake duration.

In some embodiments, the increase in distance or geo-fence eye may vary based on a velocity or a range (e.g., 5 centimeters and 10 centimeters) of a shaking movement associated with the mobile device. For example, the distance may increase as the user shakes the mobile device faster (e.g., with higher frequency) or as the user shakes the mobile device under a longer distance range. In some embodiments, the shaking movement of the mobile device may be detected by a motion sensor (e.g., an accelerometer, an inertial measurement unit, or the like) installed on the mobile device.

As described herein, the server may interact with one or more applications executing on user devices of entities or users. For example, the application may be obtained by the user of the mobile device from an electronic application store (e.g., as an “app”), and may be in communication with the server via one or more networks, which may be wired and/or wireless. In some embodiments, the mobile device may transmit its location to the server through the assistance of the app. This transmission of location may be performed as part of having the app open in the mobile device, or in response to the user shaking the mobile device. In some embodiments, the app may require detection of shaking of the mobile device longer than a certain threshold time duration (e.g., 1 second) to trigger the display of notifications based on signals received from the server. In some embodiments, the location of the mobile device may be provided to the server using information from a Global Positioning System (GPS) module installed on the mobile device. In some embodiments, the mobile device may provide its location to the server before the mobile device is shaken. In some embodiments, the mobile device may send a request for information (e.g., notification of users, offers, or entities within a certain distance from the mobile device) in response to the mobile device being shaken.

In some embodiments, the particular notification that is provided to the user of the mobile device may be selected based on a user input. For example, after shaking of the mobile devices detected exceeds the minimum threshold duration (e.g., one second), the app may present a menu to the user requesting selection of the type of notification that is desired. As an example, the menu may provide a graphical button for each of users, offers or entities, and a corresponding notification will be provided after selection of one of users, offers or entities. In some embodiments, the app may be configured to display only one type of notification and/or may default to displaying a particular type of notification (e.g., notification of other nearby users of the app).

In some embodiments, the type of notification provided may be context sensitive. For example, the app may have a map screen and the app may be configured to display particular notifications upon detecting shaking for a threshold duration while the map screen is being shown. For example, shaking of the mobile device while viewing the map screen may result in notifications showing other active users within a geofence around the user, or offers within a geofence around the user. As another example, shaking of the mobile device within a business identified as being part of a network of business users of the app may result in the display of offers, which may also take the form of a menu of services or products offered by the business.

In some embodiments, upon receiving a request for notification of users, offers or entities from the mobile device through one or more networks, the server may compare the location of the mobile device to location information (e.g., respective addresses or GPS coordinates) associated with users or entities accessible by and/or within a location database of the server, or offers with particular targeted locations. Based on the comparison, the server may send a signal, or other information, to the mobile device to notify the user of users (e.g., other users) or entities that are located within a distance from the user (e.g., a threshold distance, such as a fixed or adjustable threshold). The server may additionally provide information identifying offers that are available within the distance from the user.

In some embodiments, the server may receive a feature, or other information, associated with shaking movement of the mobile device along with the location of the mobile device. The feature may be generated by a processor (e.g., a general-purpose processor, a digital signal processor (DSP) or an application specific integrated circuit (ASIC)) of the mobile device based on a motion signal generated by a motion sensor of the mobile device. More specifically, the feature may indicate how long (e.g., 2.6 seconds, 4.3 seconds, 6.9 seconds, and 9.1 seconds) the shaking of the mobile device is detected. The server may then compare the feature to one or more durational thresholds (e.g., 2 seconds, 4 seconds, 6 seconds, and 8 seconds) to generate the distance, with distance increasing with durational threshold. For example, the distance would be 100 meters if the feature indicates that the user shook the mobile device for 2.6 seconds but the distance would be 300 meters if the feature indicates that the user shook the mobile device for 4.3 seconds. Based on the generated distance and the location of the mobile device, the server may identify users, offers or entities located within the distance from the location of the mobile device. Subsequent to the identification, the server may transmit a signal to the mobile device indicating users, offers or entities located within the distance from the location of the mobile device to facilitate further interactions between the user of the mobile device and the users, offers or entities indicated in the signal. In some other embodiments, the distance may be generated by the mobile device and transmitted to the server along with the location of the mobile device. As such, in some embodiments, the server may identify from a location database users, offers or entities within the distance from the location of the mobile device without first calculating the distance.

In some embodiments, the server may apply one or more additional criterion for identifying users, offers or entities located within the distance from the location of the mobile device. For example, the server may identify another user (who possesses another mobile device) located within the distance from the location of the mobile device if the other user shakes their other mobile device within a time interval (e.g., 5 minutes) before the user shakes their mobile device. Specifically, location information associated with the other user may be transmitted to the server when the other user shakes the other mobile device and may be stored within the location database of the server along with a timestamp indicating when the location information associated with the other user is received and stored. Upon receiving the location of the mobile device, the server may look into the location database for location information stored during an interval of time (e.g., past 5 minutes) according to associated timestamps, and identify the other user if the location information associated with the other user shows that the other user is within the distance from the location of the mobile device. In some embodiments, location information associated with the other user may be transmitted to the server before the other user shakes the other mobile device. For examples, the location information associated with the first user may be transmitted to the server periodically or irregularly in time without being triggered by the other user shaking the another mobile device.

As described herein, an entity may include any business, company, and/or user, which may have offers (deals) related to goods, products, services, and so on. For example, an entity may be a provider of an offering associated with a deal. An example entity may include a restaurant, and an example deal may include a particular dinner. The example deal may represent a reduction in cost from a normal amount, and the entity may offer the example deal for a limited time and/or only to specific users (e.g., a specific number of users). Another example entity may include a masseuse, and an example deal may include a massage. As will be described below, the entity may utilize user interfaces to create specific deals for storage by the system. Each created deal may describe particular aspects, such as an indication of what is being offered (e.g., a dinner, details related to the dinner, and so on), a cost associated with the deal, a location and/or description of the entity offering the created deal, an expiration date associated with the deal, and so on. In some embodiments, the signal indicating users or entities within the distance from the mobile device may also indicate deals associated with the entities. For example, in response to receiving the signal that the mobile device has been shaken by the user and determining the location of the mobile device, the server may transmit the signal indicating entities and associated deals to the mobile device. Upon receiving the signal, the mobile device may display a notification (e.g., through a list of entries on a graphical user interface (GUI)) to the user such that the user may know not only what entities are located within the distance from the location of the user but the associated deals the entities offer, or what offers are associated with locations within the distance.

In some embodiments, the offers that are presented to the user may be customized or sorted to, e.g., increase the relevance to the user. For example, the displayed offers may be filtered based on previous activity by the user, such as previous orders or offers that have been utilized, and/or activity by other users. As an example, notifications of offers may prioritize or show only offers that have been utilized by other users within a particular duration (e.g., a given number of minutes, hours, or days). In some embodiments, the displayed users, offers or entities may be filtered by using machine learning models that may include trained artificial neural networks to predict users, offers or entities a user is interested based on previous user interactions or selections.

According to some embodiments, the notification to the user may take the form of texts and may not require operating a GUI or a web-based application that may lack text capability. For example, a web application-based scheme may require notifications to be provided via specific applications installed on user devices. Since users may ignore and/or disable these notifications, texting may sometimes provide a more established and assured method of providing the notifications. Additionally and optionally, other forms of notification mechanism may be utilized to notify the user of the mobile device what users, offers or entities are located within a distance from the user. For example, upon shaking the mobile device, the user may be notified through voice message regarding entities within the distance from the user along with deals offered by the identified entities.

In some embodiments, the mobile device may present a user interface showing a list of entries that includes users within the distance from the location of the user in response to receiving the signal (e.g., from the server) indicating users located within the distance from the location of the user. The mobile device may then receive a selection of a first entry that corresponds to a first user with whom the user of the mobile device intends to have further interaction. For example, upon selecting the first user, the user may use the mobile device to send a message, a coupon, a gift card or the like to the first user.

In some embodiments, as discussed herein, in response to the user's shaking, the mobile device may present various information to the user depending on what information is displayed by the mobile device while the user shakes the mobile device. For example, when the user shakes the mobile device while the mobile device is displaying a business page, the mobile device may receive the signal indicating entities located within the distance from the mobile device along with business menu associated with those entities. Then, the mobile device may present (e.g., through an application program or user interface) business menu associated with entities that are located within a distance from the user. As another example, when the user shakes the mobile device while the mobile device is displaying a coupon page, the mobile device may receive the signal indicating entities located within the distance from the mobile device along with coupons those entities offer. Then, the mobile device may obtain the offers (e.g., coupons) associated with the entities indicated in the signal. Advantageously, such operation through shaking the mobile device allows the user to obtain information, including offers such as deals, or coupons, or the like more efficiently.

In some embodiments, the users, offers or entities that are eligible to be indicated in the signal transmitted from the server to the mobile device may be constrained by customized setting of the user of the mobile device. For example, the user may limit the users that will be indicated by the signal to one or more previously-identified persons or friends. Specifically, by shaking the mobile device, the user may then receive notification that a particular person is within a distance from the user and may easily share information (deals associated with an entity) or send gifts (e.g., gift cards) with that particular person. Advantageously, the user may quickly share information with others by shaking the mobile device of the user, as discussed herein.

Thus, the technical scheme described herein may improve upon prior applications or systems. For example, as described herein, prior applications may not enable triggering information sharing through physically moving (e.g., shaking) a mobile device of a user. Advantageously, triggering acquisition of information by shaking the mobile device saves the user from the efforts such as activating the screen of the mobile device, swiping or switching across interfaces or application programs, navigating through various icons or buttons before a request for particular information may be triggered. For example, it will be appreciated that other mechanisms for triggering notifications (e.g., graphically intense triggering operations) may entail more operation time. Shaking a mobile device, however, may be performed quickly and intuitively, thereby allowing the user of the mobile device to more easily acquire and exchange information (e.g., offers, deals, coupons and messages) with users or entities that are actually near a user's current location. The amount of information received may further be adjusted based on the duration of the shaking (e.g., a shaking of shorter duration may lead to a notification including fewer users, offers or entities), effectively requiring no additional operations on the part of the user. Therefore, the present disclosure represents an improvement in useability and information sharing using computing devices.

The foregoing aspects and many of the attendant advantages of this disclosure will become more readily appreciated as the same become better understood by reference to the following description, when taken in conjunction with the accompanying drawings.

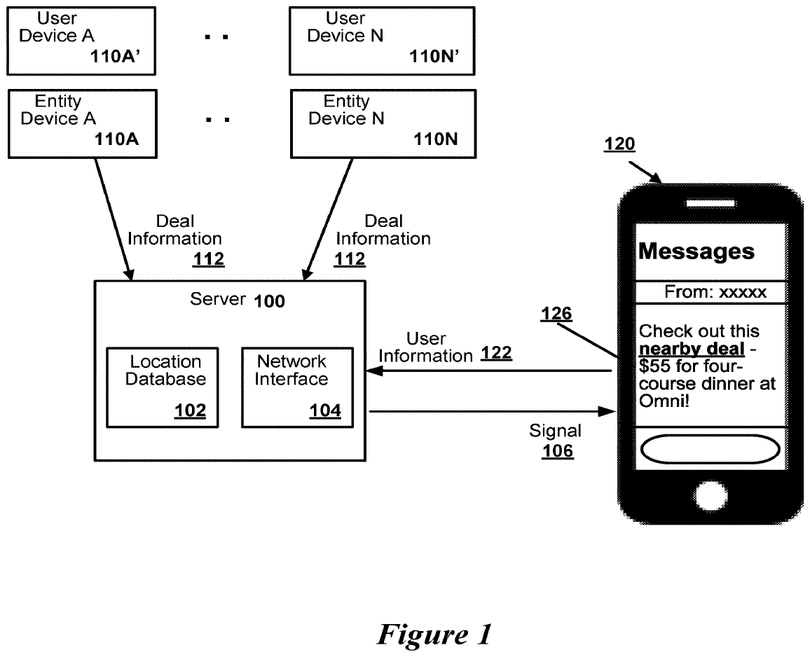

FIG. 1 depicts an example block diagram of a system in which some embodiments of the present disclosure may be implemented to generate motion-triggered notifications to a user. In some embodiments, a signal 106 may be sent from a server 100 to a mobile device 120 in response to detecting the shaking of the mobile device 120. As shown in FIG. 1, the server 100 is in communication with entity devices A-N 110A-110N, user devices A-N 110A′-110N′, and a mobile device 120 (e.g., smart phone, tablet, wearable device, etc.) of a user. The server and the various devices may be interconnected via wired connections and/or, more preferably, wireless connections. The server 100 may include one or more computers or one or more virtual machines executing on a system of one or more computers. The entity devices A-N 110A-110N may be systems or devices (e.g., tablets, smart phones, wearable devices, laptops, and so on) that are associated with respective entities. As described above, an entity may include a business associated with, for example, one or more deals, offers, coupons, and items available for selection by users. The user devices A-N 110A′-110N′ may be user devices (e.g., smart phone, tablet, wearable device) associated with other individual users and may be similar to or the same as the mobile device 120.

The server 100 may receive information from, and provide information to, the entity devices A-N 110A-110N, user devices A-N 110A′-110N′ and mobile device 120. As will be described in more detail below, each entity device may utilize an application associated with the server 100. For example, entity device A 110A may execute an application obtained from an electronic application store. As another example, entity device A 110A may execute software configured to communicate with the server 100. As another example, entity device A 110A may present a web page generated, at least in part, by the server 100. In this example, the web page may be associated with a web application implemented by the server 100. In this way, the entity devices A-N 110A-110N may utilize user interfaces generated by the application, or presented via web pages, to create deal information 112.

As described above, deal information 112 may include information describing deals (which may also be referred to as offers) available for selection. For example, a particular deal may indicate goods, services, products, and so on that are being offered via the particular deal. As another example, the particular deal may indicate an associated cost. As another example, the particular deal may indicate a category associated with the particular deal (e.g., restaurant, bar, hotel, and so on). A user of entity device A 110A, for example, may therefore specify information related to one or more deals. The server 100 may store deal information 112 for the entity devices A-N 110A-110N, such that the user of the mobile device 120 may select deals for utilization. The server may further store information (e.g., location, identity or the like) associated with users of the user devices A-N 110A′-110N′, such that the user of the mobile device 120 may select for further interaction (e.g., sending message, sharing coupons, sending gift cards or the like).

The server 100 may include a location database 102 that may obtain and store information about the locations of user devices A-N 110A′-110N′ and the mobile device 120, and then identify whether the mobile device 120 is located proximate to locations of an entity or other users that are associated with the user devices A-N 110A′-110N′. For example, the mobile device 120 is illustrated as providing the user information 122 to the server 100. In some embodiments, the user information 122 may be provided when the mobile device 120 detects that the user in possession of the mobile device 120 has shaken the mobile device 120. In some embodiments, the user information 122 may include a request to receive notification of users, offers or entities nearby the mobile device 120. In some embodiments, the mobile device 120 may have to detect that it has been shaken continuously for longer than a threshold period of time (e.g., 1 second) to trigger the transmission of the user information 122 from the mobile device 120 to the server 100. In some embodiments, the frequency (e.g., one back-and-forth shake per second) or the range (e.g., 5 centimeters) may have to exceed corresponding thresholds to trigger the transmission of the user information 122. The server 100 may also include a network interface 104 that allows the server 100 to communicate with the entity devices A-N 110A-110N, the user devices A-N 110A′-110N′ and the mobile device 120.

In some embodiments, the user information 122 may include the location of the mobile device 120. The location of the mobile device 120 may be provided by a GPS module installed on the mobile device 120. In some embodiments, the user information 122 may further include a feature associated with the shaking movement of the mobile device 120. Specifically, the feature may indicate or represent a temporal duration of the shaking movement of the mobile device 120. For example, the feature may indicate that the mobile device 120 has been shaken for 2.5 seconds, 4.1 seconds or any other period of time. In some embodiments, the location of the mobile device 120 may be transmitted to the server 100 before the mobile device 120 transmits to the server 100 the user information 122, which may be triggered by a user shaking the mobile device 120. In some other embodiments, the location of the mobile device 120 may be sent to the server 100 as part of the user information 122 triggered by the detection of shaking for a duration exceeding the threshold duration; for example, the location of the mobile device 120 may be updated in response to the shaking.

After receiving the user information 122, the server 100 may identify entities or other users that are within a distance from the mobile device 120, or offers associated with that distance from the mobile device 120. For example, the server 100 may identify an entity (e.g., associated with one of the entity devices A-N 110A-110N) or another user (e.g., associated with one of the user devices A-N 110A′-110N′) that is within a distance from the mobile device 120. In some embodiments, the distance may be determined based on the user information 122. For example, the distance may be determined based on the feature (e.g., the temporal duration of the shaking movement of the mobile device 120) included in the user information 122. Based on the location of the mobile device 120 included in the user information 122 and the determined distance, the server 100 may identify entities, offer or other users within the distance from the location of the mobile device 120 by accessing the location database 102 that stores the location information of the entities associated with the entity devices A-N 110A-110N, offers or users associated with the user devices A-N 110A′-110N′.

Upon identifying one or more entities or other users located with the distance from the mobile device 120, the server may cause a signal 106 to be transmitted to the mobile device 120. The signal 106 may indicate entities, offer or other users that are located within the distance from the location of the mobile device 120. The signal 106 may further include information associated with an entity, such as deals, items, coupons offered by the entities.

Responsive to receiving the signal 106, the mobile device 120 may display a notification to the user of the mobile device 120 to indicate which entities or other users are located within the distance from the location of the mobile device 120. The notification to the user of the mobile device 120 may take different forms, such as pure texts or texts along with graphical icons. In some embodiments, the notification may be displayed as part of an application program that is executed on the mobile device 120. As such, the notification may be presented through a user interface (e.g., a GUI) associated with the application program.

In some embodiments, the same application program executed on the mobile device or a similar application program may be executed on the server 100. The application executed on the server 100 may allow the server to interact with the application program executed on the mobile device 120.

In some embodiments, upon receiving the user information 122, an application program or software executed on the server 100 may generate a list of other users (e.g., the users associated with the user devices A-N 110A′-110N′) that have shaken their user devices within a certain time frame and/or within a certain distance from the mobile device 120. For example, if the user device A 110A′ has been shaken within five minutes before the mobile device 120 is shaken and the user device A 110A′ is within 500 meters from the mobile device 120, the application program executed on the server 100 may generate a list of users including the user of the user device A 110A′. Then, the information associated with the user of the user device A 110A′ may be included in the signal 106 that is transmitted from the server 100 to the mobile device 120. In some embodiments, the application program executed on the mobile device 120 may then present the information associated with the user of the user device A 110A′ through a graphical user interface.

In some embodiments, the notification to the user may take the form of a list of entries, where each entry identifies an entity or a user that is within the distance of the mobile device 120. In some embodiments, the notification may show a deal associated with a particular entity that is within the distance from the mobile device 120. For example, when the user of the mobile device 120 shakes the mobile device 120 for 2.1 seconds, the mobile device 120 may receive the signal 106 indicating entities located within 300 meters from the location of the mobile device 120.

In the example of FIG. 1, the mobile device 120 is presenting a text message that describes a nearby deal. The nearby deal indicates a location of an entity offering the deal (e.g., “Omni”), an offering associated with the nearby deal (e.g., four-course dinner), and a cost associated with the nearby deal (e.g., $55). A user of the mobile device 120 may interact with the text to select the nearby deal. For example, the text may include a link 126. Upon selection of the link 126 by the user, the mobile device 120 may provide information to the server 100 confirming the selection. Payment associated with the nearby deal may be automatically handled by the server 100. For example, the server 100 may have a payment instrument associated with the user, and may then charge the payment instrument. As another example, the mobile device 120 may include payment functionality and may confirm that the user is selecting the nearby deal. In this example, the user may provide biometric confirmation, such as fingerprint or face ID, and the payment may be processed by the mobile device 120. As another example, a user interface may be presented on the mobile device 120 to effectuate payment. For example, the application may present a payment screen. Optionally, the server 100 may provide a notification or otherwise transmit information to one of the entity devices A-N 110A-110N associated with the entity offering the deal.

As will be described, other types of interactions between the mobile device 120 and the entity devices A-N 110A-110N or the user devices A-N 110A′-110N′ may also be triggered by a shaking movement of the mobile device 120. As such, transactions or interactions between the mobile device 120 and entities or other users within a certain distance from the mobile device 120 may be easily initiated by shaking the mobile device 120, saving the user from the efforts such as manipulating the touch panel of the mobile device 120, and providing confirmation of desired interactions based on synchronized shaking of devices (e.g., the system may be configured to confirm that devices that are desired for mutual interaction have each been shook within a certain duration to move forward with the interaction).

Although not explicitly shown in FIG. 1, in some embodiments, as discussed herein, the mobile device 120 may receive, from the server 100, offers associated with a location that is within a certain distance from the mobile device 120. In other words, the mobile device 120 may receive an offer that is available within the certain distance from the location of the mobile device 120 even if an entity making that offer is not within the certain distance from the location of the mobile device 120.

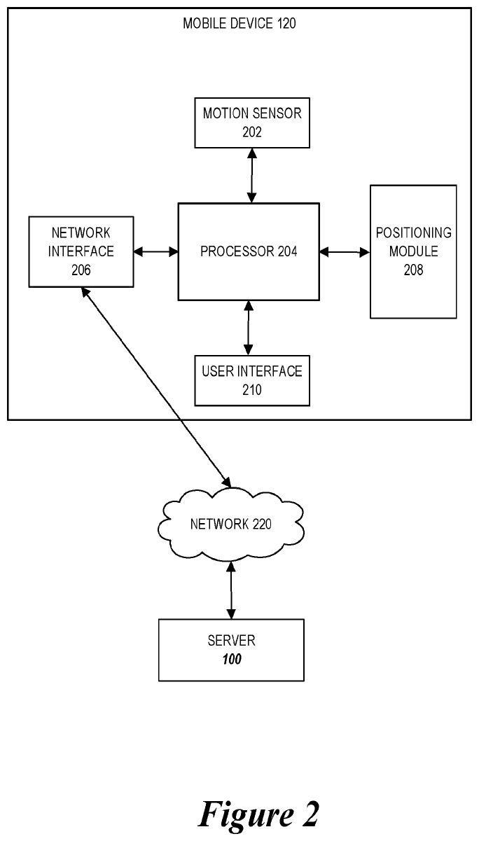

FIG. 2 depicts an example block diagram representative of the mobile device of FIG. 1. The mobile device 120 of FIG. 2 may be configured to allow the user of the mobile device 120 to trigger a notification about entities or users or offers within a distance of the mobile device 120 by shaking the mobile device 120. As illustrated in FIG. 2, the mobile device 120 includes a motion sensor 202, a processor 204, a network interface 206, a positioning module 208, and a user interface 210. In some embodiments, the processor 204 may be embodied as any type of processor capable of performing functions as described below. The processor 204 may be embodied as a microprocessor, central processing unit (CPU), digital signal processor, microcontroller, or other processor or processing/controlling units. As illustrated in FIG. 2, the processor 204 is in communication with the motion sensor 202, the positioning module 208, the network interface 206 and the user interface 210.

In some embodiments, the positioning module 208 may be a Global Positioning System (GPS) receiver or a Global Navigation Satellite System (GNSS) receiver. In some embodiments, the positioning module 208 may utilize other technologies capable of providing location or position of the mobile device 120. In some embodiments, the motion sensor 202 may be an accelerometer or other type of sensors capable of determining motion (e.g., a shaking movement) associated with the mobile device 120. In some embodiments, the user interface 210 may be a graphical user interface (GUI) or other type of user interfaces capable of facilitating interactions between a user and the mobile device 120.

The network interface 206 may support one or more wireless networking protocols (e.g., Wi-Fi/IEEE 802.11, or another wireless networking standard). However, in various embodiments, network interface 206 may support communication via any suitable wired or wireless general data networks, such as other types of Ethernet networks or radio wave-based networks, for example. As examples, network interface 206 may support communication via telecommunications/telephony networks such as analog voice networks or digital fiber communications networks, via storage area networks such as Fibre Channel SANs, or via any other suitable type of network and/or protocol.

The network 220 may include any appropriate network, including an intranet, the Internet, a cellular network, a local area network or any other such network or combination thereof. In the illustrated embodiment, the network 220 is the Internet. Protocols and components for communicating via the Internet or any other types of communication networks are known to those skilled in the art of computer communications and thus, need not be described in more detail herein.

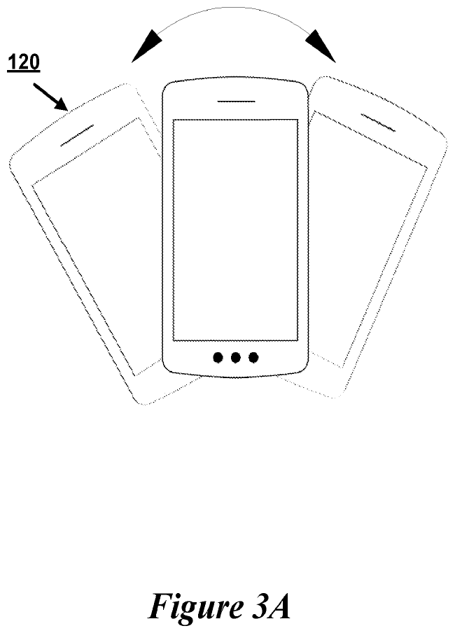

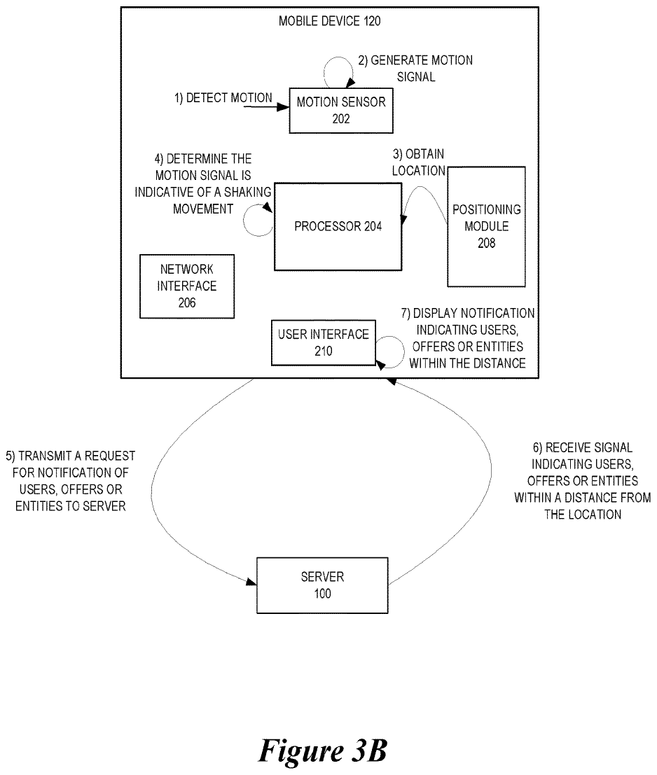

In operation, when a user of the mobile device 120 moves the mobile device 120 in a certain manner (e.g., shaking the mobile device 120 as illustrated in FIG. 3A), the motion sensor 202 may detect such action on the part of the user and generate a motion signal. The processor 204 may then process the motion signal to determine that the motion signal indicates a shaking movement of the mobile device 120. In response to determining that the motion signal is indicative of the shaking movement associated with the mobile device 120, the processor 204 may transmit a request for a notification of users, offers or entities nearby the location (e.g., provided by the positioning module 208) of the mobile device 120 through the network interface 206, the network 220 to the server 100 to request for information (e.g., the notification of users, offers or entities) from the server 100. In some embodiments, the amount of information provided to the mobile device 120 is correlated with the feature of the motion of the mobile device 120. For example, as the shaking movement of the mobile device 120 increases duration, the amount of information received by the mobile device 120 from the server 100 may increase. As such, the user of the mobile device 120 may easily trigger acquisition of information from the server 100 by shaking the mobile device 120. The interactions between the mobile device 120 and the server 100 following a shaking movement by the user of the mobile device 120 are described in greater detail in FIG. 3B.

With reference to FIG. 3B, illustrative interactions will be described depicting how elements of the mobile device 120 of FIG. 2 (e.g., the motion sensor 202 and the processor 204) may provide for motion-triggered information exchange and interactions.

The interactions of FIG. 3B begin at (1), where the motion sensor 302 detects a motion associated with the mobile device 120. As described above, the motion may be a shaking movement (applied by a user in possession of the mobile device 120) of the mobile device 120.

At (2), the motion sensor 302 may generate a motion signal based on the motion detected at (1). The motion signal may include information that is indicative of the characteristics of the motion of the mobile device 120. In some embodiments, the motion signal may include the velocity or acceleration or moving distance range of the mobile device 120 along three dimensions (e.g., x-axis, y-axis, and z-axis).

At (3), the positioning module 208 may obtain a location of the mobile device 120 and provide the location to the processor 204. It should be noted that the operations (1)-(7) described in FIG. 3B may be performed in different orders, as will be appreciated by a person skilled in the art. In some embodiments, some of the operations (1)-(7) may be performed concurrently or at least overlapped in time. For example, it is not necessary that (3) be performed after (2) and before (4). In some embodiments, the positioning module 208 may obtain location of the mobile device 120 in response to the processor 204 determining that the motion signal is indicative of a particular motion associated with the mobile device.

At (4), the processor 204 may determine that the motion signal generated by the motion sensor 202 is indicative of a shaking movement of the mobile device 120. In some embodiments, the processor 204 may process information included in the motion signal to determine if the mobile device 120 is being shaken. For example, if the degree of acceleration indicated in the motion signal is lower than a threshold, the processor 204 may determine that there is no motion associated with the mobile device 120 that should trigger further operation.

Responsive to determining that the motion signal indicates a shaking movement of the mobile device 120, at (5), the mobile device 120 may transmit (through the network interface 206) a request for notification of users, offers or entities within a distance from the location of the mobile device 120 to the server 100. In some embodiments, the request for notification of users, offers or entities may be transmitted in response to the user of the mobile device 120 being presented with a menu or prompt for selecting whether the notification should include users, offers or entities within the distance from the location of the mobile device 120. In some embodiments, the mobile device 120 may also transmit other information to the server 100 in response to the detection of the shaking movement. For example, the mobile device 120 may also transmit a feature of the motion signal to the server 100. The feature may be calculated by the processor 204 based on the motion signal. Further, the feature may indicate the temporal duration (e.g., how long the mobile device is shaken) of the motion of the mobile device 120. The feature may be utilized by the server 100 to determine a distance from the location of the mobile device 120, where entities, offers or other users within the distance from the location of the mobile device 120 may be indicated in a signal to be transmitted from the server 100 to the mobile device 120 and entities, offers or other users outside the distance from the location may not be indicated. In some embodiments, the mobile device 120 may transmit its location to the server 100 before the mobile device 120 is shaken. For example, the mobile device 120 may transmit its location to the server 100 periodically (e.g., every several minutes) or irregular in time.

At (6), the mobile device 120 may receive a signal from the server 100, where the signal is indicative of users, offers or entities within the distance from the location of the mobile device 120. In some embodiments, the distance from the location of the mobile device 120 may correlate with a feature of the motion signal generated by the motion sensor 202. For example, the distance may increase as the feature of the motion signal indicates that the mobile device 120 is being shaken for a longer period of time. As discussed above, based on the distance and the location of the mobile device 120, the server may identify other users, offers or entities within the distance from the location of the mobile device 120 by looking into the server's location database 102.

Then, at (7), the mobile device 120 may display, through the user interface 210, a notification to the user of the mobile device 120 to indicate users, offers or entities within the distance from the mobile device 120. Based on such notification, the user of the mobile device 120 may select particular users, offers or entities to engage in further interactions.

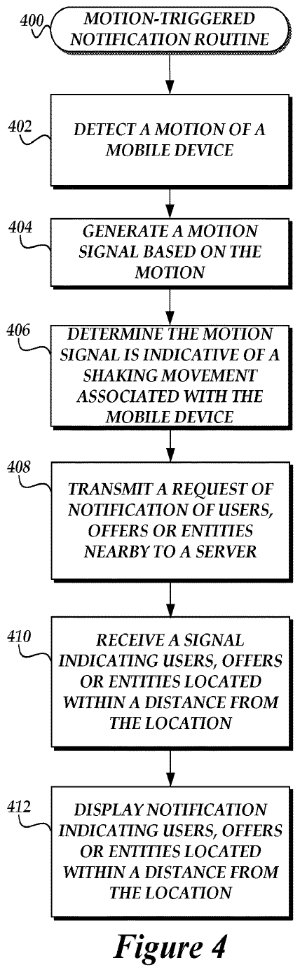

With reference to FIG. 4, an illustrative routine 400 for triggering notification indicating users, offers or entities within a geofence of a mobile device (e.g., the mobile device 120) will be described. The motion-triggered notification routine 400 may be implemented, for example, by the mobile device 120 of FIG. 2. The routine 400 may allow the mobile device 120 to receive from the server 100 information about users, offers or entities within a distance from the mobile device 120.

The routine 400 begins at block 402, where the mobile device 120 detects a motion of the mobile device 120. In some embodiments, the motion may be caused by a user of the mobile device 120. In some embodiments, the motion may be a shaking movement of the mobile device 120 or other types of movements of the mobile device 120.

At block 404, the mobile device 120 (e.g., the motion sensor 202 of the mobile device 120) may generate a motion signal based on the motion. In some embodiments, the motion sensor 202 may be an accelerometer and the motion signal may indicate the acceleration of the mobile device 120 along one or more of the x-axis, y-axis, and z-axis.

At block 406, the processor 204 of the mobile device 120 may determine that the motion signal is indicative of a shaking movement associated with the mobile device 120. In some embodiments, the processor 204 may set a threshold and determine a feature of the motion signal. The processor may then determine that the motion signal is indicative of the shaking movement if the feature exceeds the threshold.

At block 408, the mobile device 120 may transmit a request of notification of users, offers or entities nearby the mobile device 120 to the server 100. In some embodiments, the transmission of the request may occur in response to the mobile device 120 determining that the motion signal is indicative of the shaking movement associated with the mobile device 120. In some embodiments, the location of the mobile device 120 may be transmitted along with the request of notification. In some embodiments, the location of the mobile device 120 may be transmitted to the server 100 before the mobile device determining that the motion signal is indicative of a shaking movement associated with the mobile device 120. In some embodiments, the transmission of the request may further be in response to the mobile device 120 displaying a menu or prompt for selecting whether the notification should include users, offers or entities within the distance from the location of the mobile device 120, and subsequently receiving an input indicating the user's selection of one of users, offers or entities. Thus, the request may include the selected one of users, offers or entities.

In some embodiments, in addition to transmitting the request of notification of users, offers or entities nearby the mobile device 120, the mobile device 120 may further transmit a distance (e.g., 300 meters) from the mobile device 120. The distance may be calculated by the mobile device 120 to indicate to the server 100 that the mobile device 120 intends to receive information about users, offers or entities within the distance from the location of the mobile device 120. The distance may be calculated by the mobile device 120 based on the duration of the shaking movement associated with the mobile device 120.

In other examples, in addition to transmitting the request of notification of users, offers or entities nearby to the server 100, the mobile device 120 may further transmit a feature of a motion signal of the mobile device 120. For example, the feature may indicate how long the mobile device 120 is shaken and may be utilized by the server 100 to calculate a distance from the location of the mobile device 120, where users, offers or entities within the distance from the location of the mobile device 120 may be indicated in a signal to be sent from the server 100 to the mobile device 120.

At block 410, the mobile device 120 receives a signal from the server 100, where the signal indicates users, offers or entities that are located within a distance (e.g., 300 meters) from the location of the mobile device 120. As discussed above, the distance may vary based on the temporal duration (e.g., 2 seconds, 4 seconds or 6 seconds) of the shaking movement associated with the mobile device 120 discussed at block 406.

Thereafter, at block 412, the mobile device 120 may display a notification to the user of the mobile device 120 to indicate users, offers or entities located within the distance from the location of the mobile device 120. The notification may be presented to the user of the mobile device 120 in the form of texts or be presented through an application program or a web-page based interface. Based on the notification, the user of the mobile device 120 may know users, offers or entities that are nearby (e.g., within certain distance from the location of the mobile device 120) and may engage in further interactions with one or more of the users, offers or entities that are nearby.

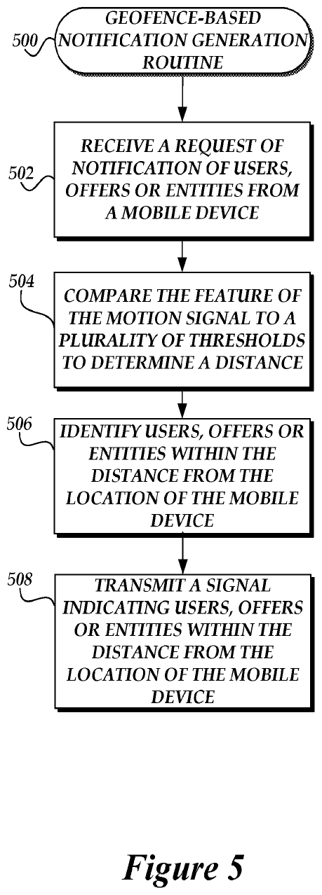

With reference to FIG. 5, an illustrative routine 500 for providing information associated with users, offers or entities within a geofence of a mobile device (e.g., the mobile device 120) will be described. The geofence-based notification generation routine 500 may be implemented, for example, by the server 100 of FIG. 2.

The routine 500 begins at block 502, where the server 100 receives a request of notification of users, offers or entities from the mobile device 120. As discussed above, in addition to receiving the request of notification, the server 100 may further receive the location of the mobile device 120, which may be provided by the positioning module 208 of the mobile device 120. In addition to receiving the request of notification of users, offers or entities from the mobile device 120, the server 100 may further receive a feature of a motion signal of the mobile device 120. Specifically, the feature may indicate a temporal duration of a shaking movement of the mobile device 120.

At block 504, the server 100 compares the feature of the motion signal associated with the mobile device 120 to a plurality of thresholds to determine a distance. In some embodiments, the feature of the motion signal may indicate a temporal duration of a shaking movement associated with the mobile device 120. Based on how long the shaking movement is, the server 100 may determine a distance for identifying information to be sent to the mobile device 120. For example, the plurality of thresholds may be 2 seconds, 4 seconds, 6 seconds and 8 seconds. The server 100 may determine the distance to be 100 meters if the feature of the motion signal indicates the shaking movement associated with the mobile device 120 lasts above 2 seconds but less than the next threshold, 4 seconds. The server 100 may determine the distance to be 300 meters if the feature of the motion signal indicates the shaking movement associated with the mobile device 120 lasts above 4 seconds but less than the next threshold, 6 seconds. The server 100 may determine the distance to be 500 meters if the feature of the motion signal indicates the shaking movement associated with the mobile device 120 lasts above 6 seconds but less than the next threshold, 8 seconds. The server 100 may determine the distance to be 1000 meters if the feature of the motion signal indicates the shaking movement associated with the mobile device 120 lasts more than the next threshold (8 seconds in this example).

At block 506, the server 100 may identify users, offers or entities within the distance determined at block 504 from the location of the mobile device 120. The server 100 may identify these users, offers or entities based on the location of the mobile device 120, information in the location database 102, and the distance.

Thereafter, at block 508, the server 100 may transmit a signal (e.g., the signal 106) to the mobile device 120 to indicate users, offers or entities that are located within the distance from the location of the mobile device 120.

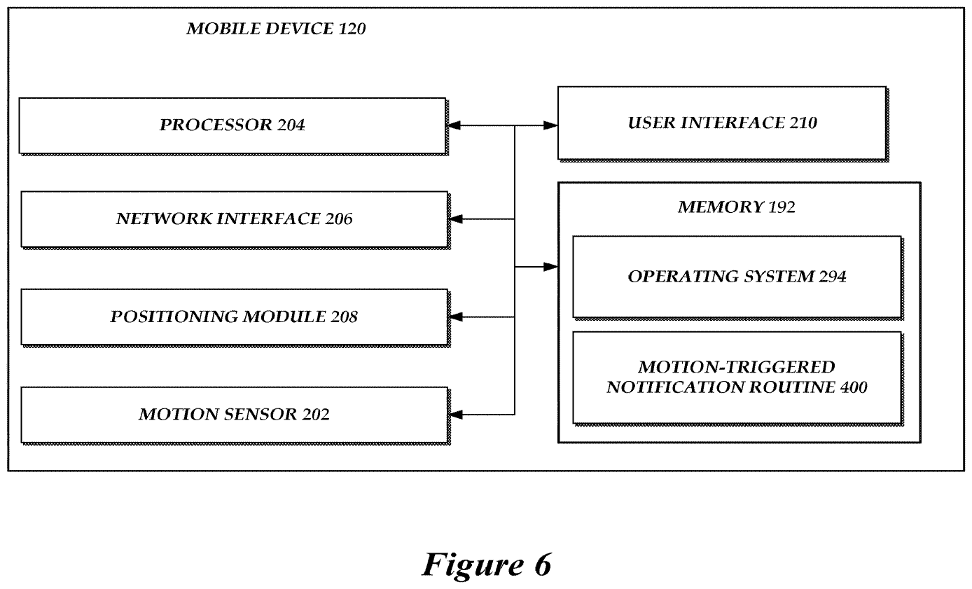

FIG. 6 depicts an example architecture of a mobile device 120 that may be used to perform one or more of the techniques described herein or illustrated in FIGS. 1-5. The general architecture of the mobile device 120 depicted in FIG. 6 includes an arrangement of computer hardware and software modules that may be used to implement one or more aspects of the present disclosure. The mobile device 120 may include more (or fewer) elements than those shown in FIG. 6.

As illustrated, the mobile device 120 includes a processor 204, a memory 192, a network interface 206, a positioning module 208, a motion sensor 202, a user interface 210, all of which may communicate with one another by way of a communication bus. An operating system 294 and a motion-triggered notification routine 400 of FIG. 4 may be loaded unto the memory 192 for execution by the processor 204. The network interface 206 may provide connectivity to one or more networks or computing systems, such as the network 220 and the server 100. The processor 204 may thus receive information from other computing systems illustrated in FIG. 1 and/or FIG. 2.

The processor 204 may also communicate with memory 192. The memory 192 may contain computer program instructions (grouped as modules or units in some embodiments) that the processor 204 executes in order to implement one or more aspects of the present disclosure. The memory 192 may include random access memory (RAM), read only memory (ROM), and/or other persistent, auxiliary, or non-transitory computer-readable media. Additionally, the memory 192 may be implemented using any suitable memory technology (e.g., one or more of cache, static random access memory (SRAM), DRAM, RDRAM, EDO RAM, DDR 10 RAM, synchronous dynamic RAM (SDRAM), Rambus RAM, EEPROM, non-volatile/Flash-type memory, or any other type of memory). The memory 192 may store an operating system 294 that provides computer program instructions for use by the processor 204 in the general administration and operation of the mobile device 120. The memory 192 may further include computer program instructions and other information (e.g., the motion-triggered notification routine 400 of FIG. 4) for implementing one or more aspects of the present disclosure.

The network interface 206 may commonly support one or more wireless networking protocols (e.g., Wi-Fi/IEEE 802.11, or another wireless networking standard). However, in various embodiments, network interface 206 may support communication via any suitable wired or wireless general data networks, such as other types of Ethernet networks, for example. Additionally, network interface 206 may support communication via telecommunications/telephony networks such as analog voice networks or digital fiber communications networks, via storage area networks such as Fibre Channel SANs, or via any other suitable type of network and/or protocol.

As discussed above, the mobile device 120 may transmit a request for notification of users, offers or entities nearby to the server 100 in response to a shaking movement associated with the mobile device 120, where the shaking movement may be detected by the motion sensor 202. Additionally, the mobile device 120 may transmit its location to the server 100 before the shaking movement or in response to the shaking movements. The location of the mobile device 120 may be obtained by the positioning module 208. In some embodiments, the positioning module 208 is a Global Positioning System (GPS) receiver or a Global Navigation Satellite System (GNSS) receiver. The transmission of the request of notification and location of the mobile device 120 may be facilitated by the network interface 206. The mobile device 120 may then receive a signal from the server indicating users, offers or entities located within a certain distance from the location of the mobile device 120, where the signal may be received by the network interface 206 and then processed by the processor 204. The mobile device 120 may then display, by the user interface 210 (e.g., a display panel), a notification indicating the users, offers or entities located within the certain distance from the location of the mobile device 120.

### Examples Applications and User Interactions

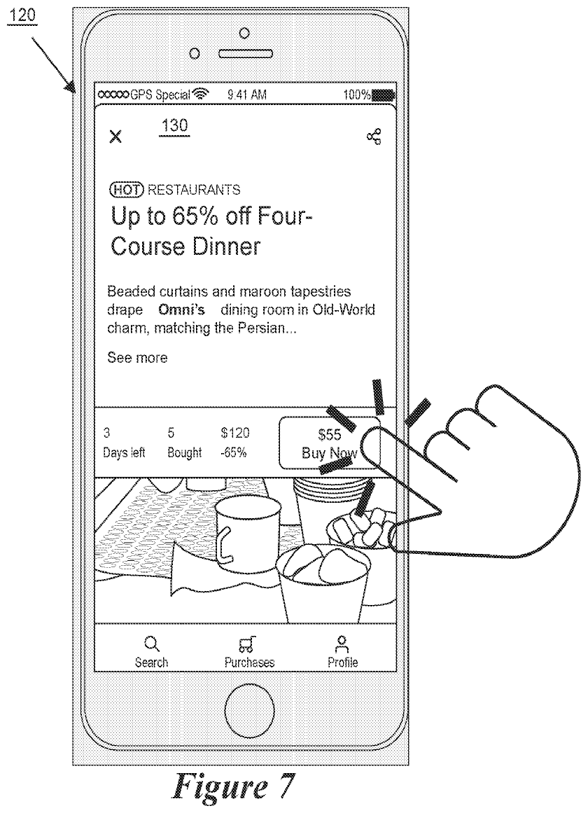

FIG. 7 illustrates interactions that may be triggered by a motion of a mobile device, such as the mobile device 120. Specifically, FIG. 7 illustrates an example user interfaces 130 (e.g., for selecting a deal) that is displayed after the mobile device 120 is shaken. As described above, with respect to FIG. 1, a signal 106 may be provided to a mobile device 120 describing a deal within a distance from the mobile device 120 after the mobile device 120 is shaken. In the example of FIG. 1, a text is provided as a notification to the user of the mobile device 120. As another example, the signal 106 may be transmitted to the mobile device 120 as a message associated with an application executing on the mobile device 120. The signal 106 may therefore cause activation of the application, such that the application graphically illustrates the deal that is within the distance from the mobile device 120, where the distance may be determined based on a feature of a shaking movement of the mobile device 120.

In the example of FIG. 7, user interface 130 may be activated by the mobile device 120 upon receiving the signal 106 from the server 100. The signal 106 may cause activation of an application program on the mobile device, and the application may then present user interface 130 in response to the activation. Similar to the text presented on the mobile device 120 in FIG. 1, user interface 130 describes information associated with the deal, which may be offered by an entity within a distance from the mobile device 120. As mentioned above, the distance may be determined based on how long the mobile device 120 is shaken.

As shown in the user interface 130, a cost (e.g., “$55”) is illustrated along with a description of the deal (e.g., “four-course dinner”) and an entity associated with the deal (e.g., “Omni”). Optionally, user interface 130 may be presented on the mobile device 120 based on selection of the link 126 included in the text illustrated in FIG. 1, where the reception of the text may be triggered by a shaking movement of the mobile device 120. Specifically, selection of the link 126 may cause activation of the application described above, and the application may present information associated with the deal. As another example, shaking the mobile device 120 may trigger the reception of the signal 106, which may activate a browser on the mobile device 120 to obtain a web page, and upon rendering the web page present user interface 130.

As illustrated in FIG. 7, a user of the mobile device 120 has interacted with an option in user interface 130 to select the deal (e.g., “Buy Now”). Upon selection, the server 100 may update profile information associated with the user of the mobile device 120 to reflect the selection. Additionally, authorization information (e.g., a QR code) may be provided to the mobile device 120 such that the user may utilize the selected deal.

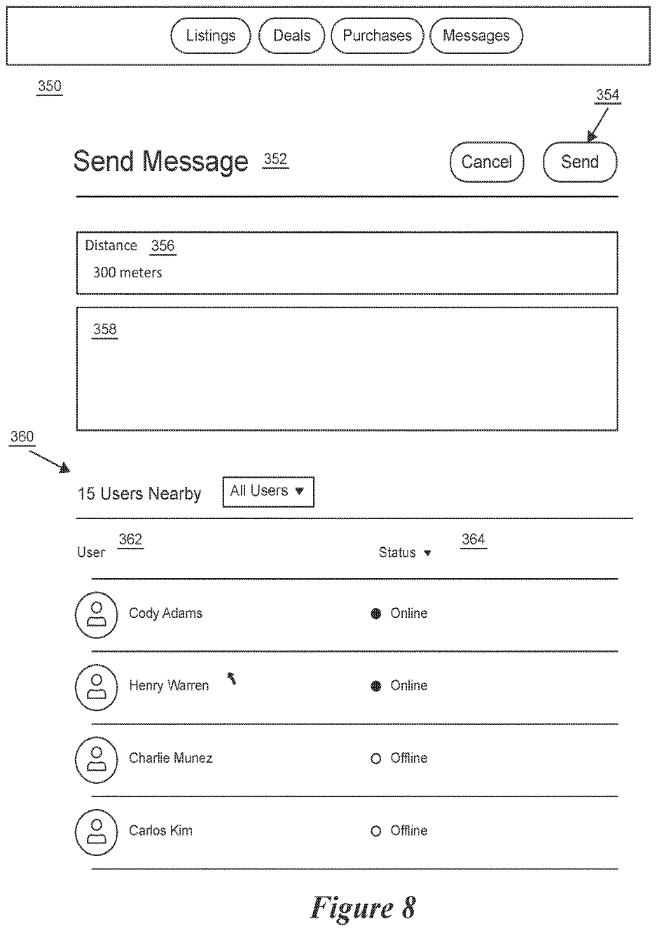

FIG. 8 illustrates an example user interface 350 that may be motion-triggered to be displayed on the mobile device 120. Specifically, the user of the mobile device 120 may see the user interface 350 displayed just by shaking the mobile device 120. User interface 350 may be generated by an application executing on the mobile device 120 or may be presented in a web page generated, at least in part, by the server 100.

As indicated in portion 352, 354 and 358, the user of the mobile device 120 may send a message by clicking on the portion 354. The user may type the message to be sent in the textual region indicated in portion 358. As indicated in portion 356, the users displayed in the portion 362 are all within 300 meters from the mobile device 120.

As displayed in portion 360, there are 15 users nearby (e.g., within 300 meters according to portion 356 from the mobile device 120) the mobile device 120. Portion 362 shows the names of the users that are within 300 meters from the mobile device 120 along with their status (shown in portion 364) associated with the application executing on the mobile device 120. Although not illustrated in FIG. 8, besides sending messages to selected users within a certain distance from the mobile device 120, the mobile device 120 may allow the users to send or share other information to selected users. For example, the mobile device 120 may cause a coupon or a gift card to be transmitted to the selected users. Further, in some embodiments, the 300 meters distance will be changed based on how long the user shakes the mobile device 120. For examples, when the mobile device 120 is shaken for 4 seconds, the mobile device 120 will display users that are within 300 meters from the mobile device 120; when the mobile device 120 is shaken for 6 seconds, the mobile device 120, will display users that are within 500 meters from the mobile device 120.

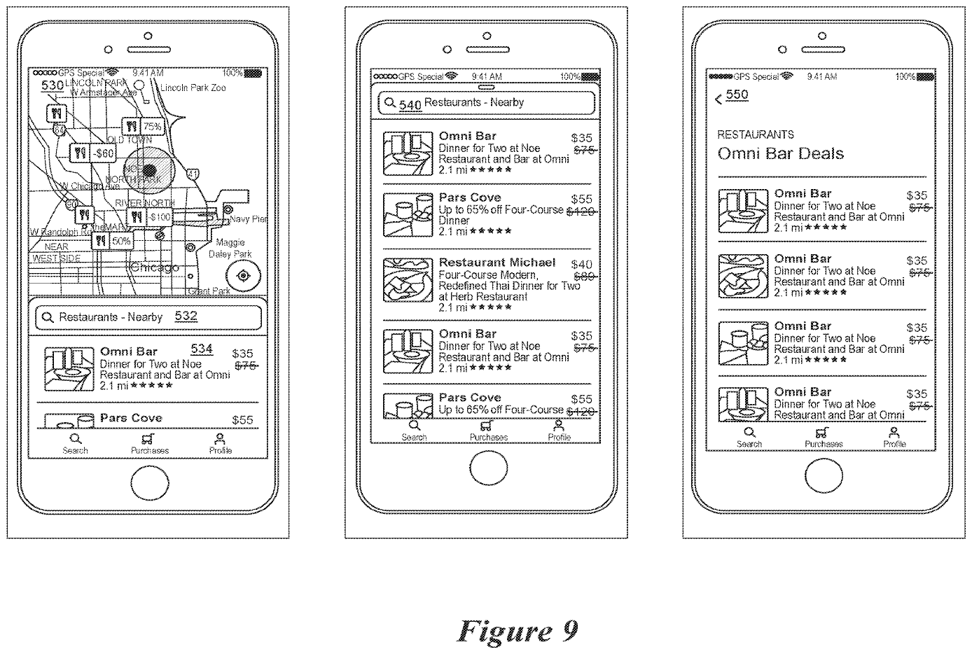

FIG. 9 illustrates example user interfaces that may be displayed on the mobile device 120 in response to a user shaking the mobile device 120. As shown in FIG. 9, a user interface 530 is presented. The user interface 530 presents a map of a particular geographic area surrounding the mobile device 120. Although not easily observed from the map, entities that are within one mile to the mobile device 120 are presented in the map and the portion 534. As illustrated in FIG. 9, four entities are within one mile to the mobile device 120. In some embodiments, the user interface 530 may display entities within different distances from the mobile device 120 based on how long the user of the mobile device 120 shakes the mobile device.

Additional information may be displayed on the mobile device in response to a shaking movement associated with the mobile device to facilitate the user performing further interactions with displayed entities. In certain embodiments, a representation may include a cost associated with a deal associated with entities displayed, a reduction from a normal cost (e.g., the deal saves $60 or the deal saves $75%), and an indication of a type of the deal (e.g., restaurant, bar, hotel). In portion 532 the user of the user device may filter the entities displayed. For example, the user may indicate that he/she is interested only in restaurants. In portion 534, more detailed information related to the entities presented on the map is included.

User interface 540 illustrates another example user interface that may be presented on the mobile device 120 in response to a user shaking the mobile device 120. In contrast to user interface 530, user interface 540 illustrates notification presented to a user of the mobile device 120, where the notification is without a map. In the user interface 540, the user may view detailed information related to more of the deals associated with entities that are within a certain distance to the mobile device of the user.

In some embodiments, the user of the mobile device 120 may select some of the entities for further operations. The mobile device 120 may display an example user interface 550 that includes deals associated with a particular entity (e.g., “Omni Bar”) in response to the user's selection of the particular entity that is displayed in portion 534. As described above, each entity may offer multiple deals available for selection. Thus, if the user selects a particular entity, user interface 550 may be presented illustrated all deals available from the particular entity. Optionally, the deals may be ordered according to cost or according to expiration date. Additionally, the deals may be ordered based on determined likelihood that the user may select the deal. For example, the system may determine that a particular deal is similar to deals historically selected by the user. As another example, the system may determine that a particular deal is for a number of people that conforms to a family size associated with the user. In this example, the system may determine that a time of day corresponds to dinner, and determine that the user may be trying to locate dinner deals for his/her family.

In some embodiments, although not illustrated in FIG. 9, the mobile device 120 may be already presenting a map when the mobile device 120 is being shaken. In these examples, in response to determining the shaking movement associated with the mobile device 120 occurs during the presentation of the map, the mobile device 120 may present deals associated with entities that are located within a certain distance from the location of the mobile device 120. As such, the user of the mobile device 120 may get detailed information about entities nearby without having to select the entities. In some embodiments, the deals presented may be filtered or adjusted based on previous orders placed by the mobile device 120. In some embodiments, the deals presented may be filtered or adjusted based on previous orders placed by other mobile devices during a specific time interval (e.g., during past 3 days, 5 days or 10 days). In some embodiments, the deals presented may be filtered or adjusted, e.g., by using machine learning models that may include trained artificial neural networks, to predict deals a user is more likely to be interested in based on previous user interactions or selections.

In some embodiments, although not illustrated in FIG. 9, the mobile device 120 may be already presenting a business page when the mobile device 120 is being shaken. In these examples, in response to determining the shaking movement associated with the mobile device 120 occurs during the presentation of the business page, the mobile device 120 may present a business menu associated with entities that are within certain distance from the mobile device 120.

In some embodiments, although not illustrated in FIG. 9, the mobile device 120 may be already presenting a coupon page when the mobile device 120 is being shaken. In these examples, in response to determining the shaking movement associated with the mobile device 120 occurs during the presentation of the coupon page, the mobile device 120 may automatically attempt to obtain coupons associated with entities that are within certain distance from the mobile device 120.

In still other examples, the motion-triggered notification techniques described above may facilitate multiple mobile devices be paired together to engage in transactions with each other. For example, when an application program that supports the motion-triggered notification techniques is running on both mobile devices, two parties at the same place may both shake their mobile devices simultaneously or within certain period of time (e.g., 5 minutes) to allow their mobile devices “find” each other and be paired together. Once paired together, one party may send information to the other party to facilitate further interaction. For example, one party may be a merchant who may generate and send an invoice to the other party (e.g., a buyer) after their devices are paired together in response to both parties shaking their devices. The other party will then see the invoice pop up on the application program and may approve the invoices to consummate the transaction. Once the invoice is approved by the buyer, money, credits, or points of value will be charged from the buyer's balance to add to the merchant's balance. As another example, a first party may be an individual or an entity who wants to transfer money to an account (e.g., a bank account) of a second party that may also be an individual or an entity. Once the two party are paired together through both shaking their mobile devices, the first party may see the second party on a list that shows transferees and may select the second party on the list to complete the money transfer.

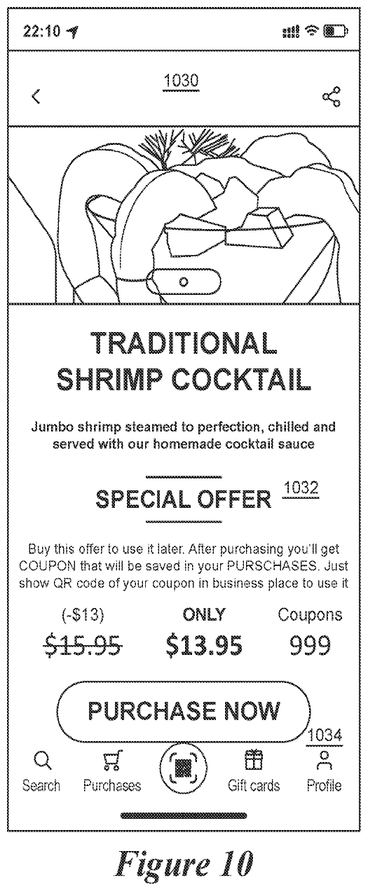

FIGS. 10-12 illustrate interactions that may be triggered by a motion of a mobile device, such as the mobile device 120, or that may influence notifications provided in response to detection of the triggering motion. FIG. 10 illustrates an example user interface 1030 for selecting a deal that may be displayed on the mobile device 120 responsive to a shaking of the mobile device 120.

As described above, with respect to FIG. 1, a signal 106 may be provided to a mobile device 120 describing an offer within a distance from the mobile device 120 after the mobile device 120 is shaken. In the example of FIG. 10, the user interface 1030 may be activated by the mobile device 120 upon receiving the signal 106 from the server 100. Similar to the text presented on the mobile device 120 in FIG. 1, the user interface 1030 describes information associated with the offer, which may be offered by an entity within a distance from the mobile device 120. As discussed herein, the distance may be determined based on how long the mobile device 120 is shaken.

As shown in the user interface 1030, a special offer 1032 at a discounted price (e.g., “$13.95”) is presented to a user of the mobile device 120 through the user interface 1030. Additionally, a message (e.g., “Buy this offer to use it later. After purchasing you'll get COUPON . . . ”) associated with the special offer 1032 shows that coupons are still available and will be given to the user of the mobile device 120 after the special offer 1032 is purchased. As illustrated in FIG. 10, the user of the mobile device 120 may purchase the special offer 1032 simply by clicking on the button 1034 (e.g., “PURCHASE NOW”).

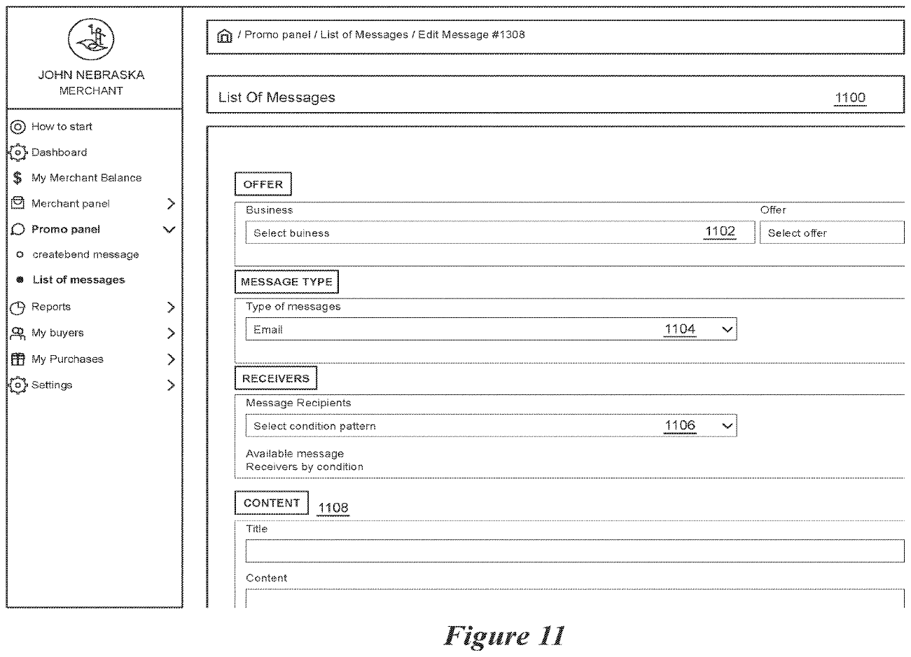

FIG. 11 illustrates an example user interface 1100 through which offers may be presented to potential customers. The example user interface 1100 may be displayed on a device, such as the entity devices A-N 110A-110N, the user devices A-N 110A′-110N′ or the mobile device 120. In some embodiments, the example user interface 1100 may be displayed on one of the entity devices A-N 110A-110N, such as the entity device 110A. As illustrated in FIG. 11, a user of the entity device 110A may be a merchant and the user interface 1100 may allow the merchant to send messages to desired recipients.

As illustrated in portions 1102, 1104, 1106 and 1108, the merchant may select a kind of business and/or deals to be offered to potential customers by selecting the portion 1102. The merchant may further specify how the offer is to be transmitted (e.g., through email, or text message) to the potential customers by selecting the portion 1104. Additionally, the merchant may select the portion 1106 to target the offer to selected recipients. Further, the merchant may edit the title and the content of the offer by operating on the portion 1108. Although not illustrated in FIG. 11, the user interface 1100 may further allow the merchant to designate one or more time slots or instants to send the offer or message to potential customers.

In some embodiments, responsive to a shaking of the mobile device 120, the offer edited by the merchant as shown in FIG. 11 may be transmitted from the server 100 to the mobile device assuming the user of the mobile device 120 is selected as a recipient based on operation associated with the portion 1106.

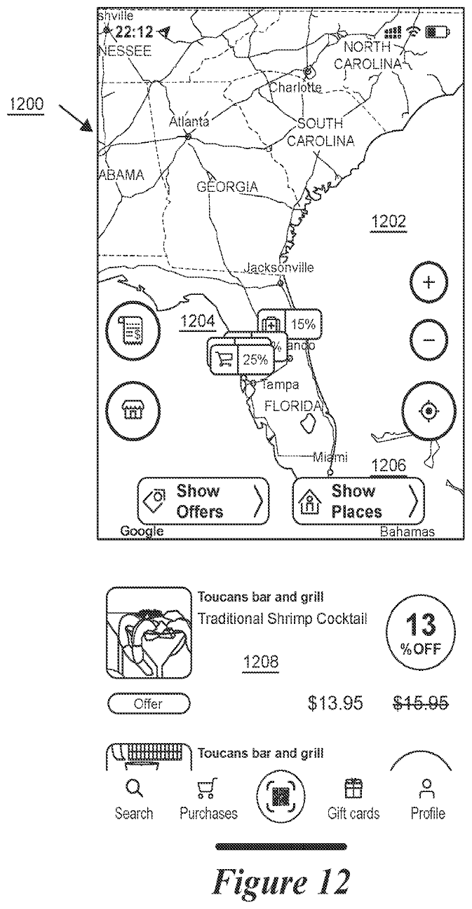

FIG. 12 illustrates an example user interface 1200 that may be displayed on the mobile device 120 in response to a user shaking the mobile device 120. As shown in FIG. 12, a user interface 1200 is presented. The user interface 1200 may present a map 1202 of a particular geographic area surrounding the mobile device 120.

As illustrated in FIG. 12, offers that are within a particular distance from the mobile device 120 may be presented in the map 1202 through the portion 1204 along with the discount (e.g., “25%”) offered.

As illustrated in FIG. 12, instead of showing offers around the mobile device 120, the user interface 1200 may allow the user of the mobile device 120 to be notified of entities or businesses within a certain distance from the mobile device 120 when the user of the mobile device 120 clicks the portion 1206 (“Show Places”). Additionally, more detailed information (e.g., pictures of the offer, discount percentage or the discounted price “$13.95”) about a particular offer may be presented to the user of the mobile device through the portion 1208.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium may be a tangible device that may retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “routine”, “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto may be performed in other sequences that are appropriate.

It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods may be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification. For example, references to “a” processor or “the” processor are simply for purposes of readability and that these references should be understood to include one or multiple processors.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments described herein may not provide all of the features and benefits set forth herein, as some features may be used or practiced separately from others. The scope of certain embodiments disclosed herein is indicated by the appended claims rather than by the foregoing description. All changes which come within the meaning and range of equivalency of the claims are to be embraced within their scope.

What is claimed:

1. A computer-implemented method implemented at a mobile device, the mobile device comprising a sensor, a processing unit and a display, the computer-implemented method comprising:
detecting, by the sensor, a motion of the mobile device;
generating, by the sensor, a motion signal based on the motion;
determining, by the processing unit, the motion signal is indicative of a shaking movement associated with the mobile device;
transmitting, to a server, a location of the mobile device;
receiving, from the server, a signal indicating users, offers or entities located within a distance from the location; and
displaying, by the display, a notification indicating the users, offers or entities located within the distance from the location.

2. The computer-implemented method of claim 1, further comprising:
determining, by the processing unit, a first feature of the motion signal; and
determining, by the processing unit, the first feature exceeds a threshold.

3. The computer-implemented method of claim 2, wherein in response to determining the first feature exceeds the threshold, the processing unit transmits the location of the mobile device and the first feature to the server.

4. The computer-implemented method of claim 2, wherein in response to determining the first feature exceeds the threshold, the processing unit transmits a request for the signal indicating the users, offers or entities located within the distance from the location.

5. The computer-implemented method of claim 2, wherein the first feature corresponds to a temporal duration of the shaking movement.

6. The computer-implemented method of claim 5, wherein the mobile device is configured to transmit a message indicative of the distance to the server, wherein the distance varies with the temporal duration.

7. The computer-implemented method of claim 6, wherein the distance further varies based on a density of potential users, offers or entities that are eligible to be indicated in the signal.

8. The computer-implemented method of claim 2, wherein the distance is positively correlated with the first feature.

9. The computer-implemented method of claim 2, wherein the first feature is a velocity of the shaking movement or a distance range of the shaking movement.

10. The computer-implemented method of claim 1, wherein the notification comprises identification of a first user, wherein location information of the first user is transmitted to the server within a first time interval before the location of the mobile device is transmitted to the server.

11. The computer-implemented method of claim 10, wherein the location information of the first user is transmitted to the server in response to a shaking movement associated with another mobile device of the first user.

12. The computer-implemented method of claim 1, further comprising:
presenting, via the display, a user interface including a list of entries, wherein the list of entries includes the users indicated in the signal;
receiving a selection of a first entry of the list of entries included in the user interface, wherein the first entry corresponds to a first user of the users; and
causing a message, a coupon, or a gift card to be transmitted to another mobile device of the first user.

13. The computer-implemented method of claim 1, further comprising:
presenting, via the display, a user interface including a map;
determining the shaking movement associated with the mobile device occurs during the presentation of the user interface including the map; and
in response to determining the shaking movement associated with the mobile device occurs during the presentation of the user interface including the map, presenting, via the display, deals associated with the entities located within the distance from the location.

14. The computer-implemented method of claim 13, wherein the deals vary based on previous orders placed by the mobile device.

15. The computer-implemented method of claim 13, wherein the deals vary based on previous orders placed by other mobile devices during a first time interval.

16. The computer-implemented method of claim 1, further comprising:
presenting, via the display, a user interface including a business page;
determining the shaking movement associated with the mobile device occurs during the presentation of the user interface including the business page; and
in response to determining the shaking movement associated with the mobile device occurs during the presentation of the user interface including the business page, presenting, via the display, a business menu.

17. The computer-implemented method of claim 1, further comprising:
presenting, via the display, a user interface including a coupon page;
determining the shaking movement associated with the mobile device occurs during the presentation of the user interface including the coupon page; and
in response to determining the shaking movement associated with the mobile device occurs during the presentation of the user interface including the coupon page, causing coupons associated with the entities indicated in the signal be obtained by the mobile device.

18. A system comprising one or more processing units configured to perform the method of any one of claims 1 to 17.

19. A computer program product comprising instructions which, when executed by a computer, cause the computer to carry out the method of any one of claims 1 to 17.

20. A computer-readable storage medium comprising instructions which, when executed by a computer, cause the computer to carry out the method of any one of claims 1 to 17.

21. A computer-implemented method implemented at a server, the method comprising:
receiving, from a mobile device, a location of the mobile device;
receiving, from the mobile device, a feature of a motion signal;
generating a distance based on the feature;
identifying users, offers or entities within the distance from the location of the mobile device; and
transmitting, to the mobile device, a signal indicating users, offers or entities located within the distance from the location of the mobile device.

22. The computer-implemented method of claim 21, wherein generating the distance comprises:
comparing the feature to one or more thresholds to generate a comparison result; and
generating the distance based on the comparison result.

23. The computer-implemented method of claim 21, wherein the feature corresponds to a temporal duration of a shaking movement associated with the mobile device.

24. The computer-implemented method of claim 23, wherein the distance varies with the temporal duration.

25. The computer-implemented method of claim 24, wherein the distance is positively correlated with the feature.

26. The computer-implemented method of claim 23, wherein the distance varies based on a density of potential users, offers or entities that are eligible to be indicated in the signal.

27. The computer-implemented method of claim 21, further comprising:
receiving location information of another mobile device associated with a first user,
wherein the first user is indicated in the signal, and wherein the location information is received within a first time interval before the location of the mobile device is received.

28. The computer-implemented method of claim 27, wherein the location information is received in response to a shaking movement associated with the another mobile device associated with the first user.

29. The computer-implemented method of claim 21, further comprising:
transmitting deals associated with the entities located within the distance from the location.

30. The computer-implemented method of claim 29, further comprising:
filtering the deals associated with the entities located within the distance from the location based on previous orders associated with the mobile device.

31. The computer-implemented method of claim 29, further comprising:
filtering the deals associated with the entities located within the distance from the location based on previous orders associated with other mobile devices.

32. A system comprising one or more processing units configured to perform the method of any one of claims 21 to 31.

33. A computer program product comprising instructions which, when executed by a computer, cause the computer to carry out the method of any one of claims 21 to 31.

34. A computer-readable storage medium comprising instructions which, when executed by a computer, cause the computer to carry out the method of any one of claims 21 to 31.
